(19) United States
(12) Patent Application Publication
(10) Pub. No.: US 2016/0267270 A1
(43) Pub. Date: Sep. 15, 2016

(54) METHOD AND SYSTEM FOR FAST INSPECTION OF ANDROID MALWARES

(71) Applicant: Electronics and Telecommunications Research Institute, Daejeon (KR)

(72) Inventors: Kyong Ha LEE, Daejeon (KR); Won Joo PARK, Daejeon (KR); Kee Seong CHO, Daejeon (KR)

(21) Appl. No.: 14/830,546

(22) Filed: Aug. 19, 2015

(30) Foreign Application Priority Data
Mar. 13, 2015 (KR) 10-2015-0035055

(51) Int. Cl. G06F 21/56; G06F 17/30

(52) U.S. Cl. CPC G06F 21/562; G06F 17/30321; G06F 2221/033

(57) ABSTRACT

Provided is a system for conducting the fast inspection of Android malwares, the system including a processor configured to compute the similarity between the signature for a given target application and one of signatures stored in a database, and a determiner configured to determine whether the target application is a malware based on the computed similarity, wherein the system relates to the technology for examining whether a certain Android application, which can be downloaded via a uniform resource locator (URL), is malicious by examining how similar the application is with the malwares and normal applications verified earlier.

### CROSS-REFERENCE TO RELATED APPLICATION

This application claims the priority benefit of Korean Patent Application No. 10-2015-0035055, filed on Mar. 13, 2015, in the Korean Intellectual Property Office, the disclosure of which is incorporated herein by reference.

### BACKGROUND

1. Field of the Invention

Example embodiments relate to a technology for examining whether a given Android application which can be downloaded through a uniform resource locator (URL) is a known malware or a repackaged application by rapidly comparing this application with both a set of malwares and normal applications verified earlier.

2. Description of the Related Art

Android operating system (OS) is one of representative operating systems for smartphones. An application developed to be operated on the Android OS, Android application, is provided in a form of an archival file which is compressed in ZIP format with Android application package file (APK) extension. The archival file (.APK) includes a set of access rights, required program libraries, and other resource files. An actual execution code in the archival file is provided is coded in Dalvik bytecode and named classes.dex. Due to the characteristics, all the source codes for an Android application can be simply acquired by uncompressing followed by decompiling procedure.

An Android malware is an Android application which includes malicious codes written with an intention to perform certain malicious actions such as stealing user's personal information or financial information after their installation. Most of Android malwares are created by embedding malicious codes into normal applications, which can be easily acquired by third-party marketplaces, by virtue of the ease of repackaging Android application.

A repackaged Android application is typically similar to the original application in many aspects except that it further includes malicious codes. Furthermore, new malicious codes tend to be created by exploiting and modifying Android malicious codes known before, not from the scratch. Thus, unknown Android malwares often share common characteristics with the malwares verified earlier.

In general, checking whether an application to be installed into a smartphone is a malware is determined by examining whether the application is the same as a malware verified before. It is also decided by examining whether the application includes a part similar to known malicious codes.

As this inspection must be performed with limited computing resources allowed in a smartphone, performing an inspection for each Android application file in a timely manner is a challenge.

### SUMMARY

An aspect provides a method and system for quickly conducting a similarity-based inspection for Android malwares.

Another aspect also provides a method and system in which a server accesses an Android application file via a uniform resource locator (URL) in order to perform an analysis on behalf of a client, thereby enabling a fast and efficient malware inspection.

Still another aspect also provides a method and system for generating a signature for a corresponding application to conduct a fast inspection by using a similarity query index rather than by directly comparing the signature with all the signatures stored in a signature database located in a server.

According to an aspect, there is provided a system for fast inspection of Android malwares, the system including a processor module configured to compute the similarity between a signature for the target application and signatures stored in a database, and a determiner module configured to determine whether the target application is a malware according to the signature similarity computed by the processor module.

The system for fast inspection of Android malwares further includes a receiver module configured to receive the signature for the target application from a smartphone.

The system for fast inspection of Android malwares further include a generator module configured to download the target application through a URL received from a smartphone and to generate the signature for the target application.

The processor module is configured to split signatures stored in a database into fixed-sized substrings, generate an inverted index with the substrings, and compute the similarity by looking up the inverted index with the substrings from the signature for the target application.

The processor module is configured to generate an inverted index by grouping data items by each substring. Each data item is composed of the actual value for a signature that includes the corresponding key value, that is substring, a position of the substring in the signature, and an identifier for an application represented by the signature.

The processor module is configured to generate substrings by splitting the signature for the target application and to look up the inverted index in order to find at least one signature which include some of the substrings from the signature for the target application.

The processor module is configured to compute the similarity between one of signatures stored in a database and the signature for the target application based on the criteria that how many substrings that both signatures share each other.

According to another aspect, there is also provided a system for fast inspection of Android malwares, the system including a request processor module configured to request a server to compute the target application, and a receiver module configured to receive information on a similarity to malwares verified earlier from the server in response to the request, wherein the server is configured to build an inverted index by dividing signatures stored in a database into substrings, then compute the similarity by looking up the generated inverted index with the signature for the target application, and finally send the similarity information in response to the requests.

The request processor module is configured to request the server to perform malware inspection by sending a URL for downloading the target application via Internet.

The request processor module is configured to generate a signature for the target application and then send the generated signature to the server to request for malware inspection.

The server is configured to build an inverted index by grouping data items by each substring as a key.

The server is configured to generate substrings by splitting the signature for the target application, search the inverted index for at least one signature that includes the substrings, and compute the similarity between one of signatures in a database and the signature for the target application based on the criteria that how many substrings that both signatures commonly share each other.

According to still another aspect, there is also provided a method of conducting a fast inspection of Android malwares, the method that includes examining, by a processor model, the similarity between a signature for the target application and signatures stored in a database, and determining, by a determiner module, whether the target application is a malware according to the computed similarity, wherein the examining process includes dividing the signatures stored in a database into substrings and building an inverted index with the substrings, and examining the similarity by comparing the signature of the target application with the signatures traversed from the inverted index.

The method of conducting the fast inspection of Android malwares also includes the receiving of the signature for the target application directly from a smartphone.

The method of conducting the fast inspection of Android malwares further includes the downloading of the target application itself with a uniform resource locator (URL) received from a smartphone and generating a signature for the downloaded target application.

The dividing process includes building an inverted index by grouping data items for each substring, using each substring as a key.

The examining process includes generating substrings from the signature for the target application and searching the inverted index for at least one signature that includes the substrings, and examining the similarity between one of the signatures stored in a database and the signature for the target application based on the criteria that how many substrings that both signatures share each other.

The examining process further includes searching for a data item, which comprises a signature value, a position of a substring in a signature, and application ID information for a corresponding substring.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 illustrates an example of a whole system to which a system for conducting the fast inspection of Android malwares is applied;

FIG. 2 illustrates an example of a system for conducting the fast inspection of Android malwares in the server perspective;

FIG. 3 illustrates an example of building a similarity query index with signatures stored in a database of a server;

FIG. 4 illustrates an example of fast search of candidate signatures with the inverted index built in FIG. 3 for a given Android application;

FIG. 5 illustrates an example of a system for conducting the fast inspection of Android malwares in the client perspective; and

FIG. 6 illustrates an example of an overall procedure of malware inspection for an Android application including the building of an inverted index and a signature search performed by using the inverted index.

### DETAILED DESCRIPTION

Reference will now be made in detail to exemplary embodiments, examples of which are illustrated in the accompanying drawings, wherein like reference numerals refer to the like elements throughout.

Terminologies used herein are defined to appropriately describe the example embodiments of the present disclosure and thus be changed depending on a user, the intent of an operator, or a custom. Accordingly, the terminologies must be defined based on the following overall description of this specification.

It will be further understood that terms, such as those defined in commonly used dictionaries, should be interpreted as having a meaning that is consistent with their meaning in the context of the relevant art and will not be interpreted in an idealized or overly formal sense unless expressly so defined herein.

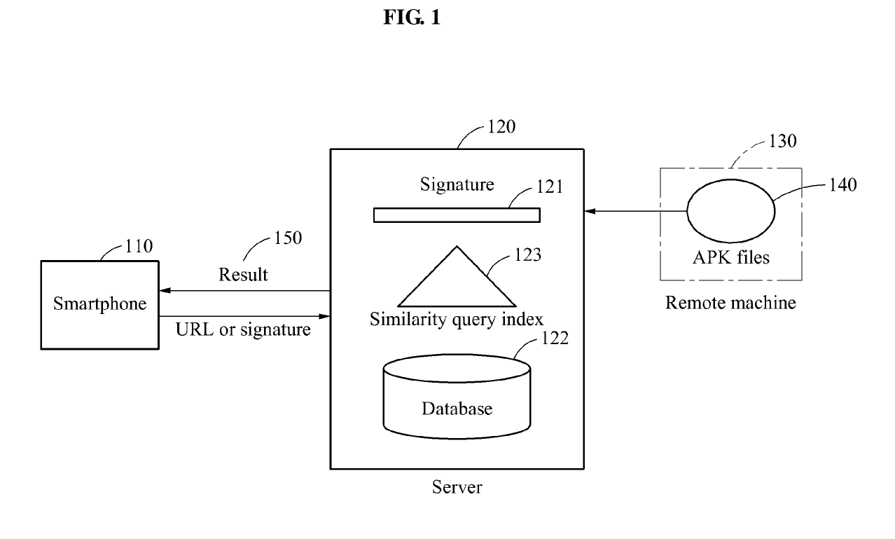

FIG. 1 illustrates a whole system 100 to which a system for conducting the fast inspection of Android malwares is applied.

In the whole system 100, a smartphone 110 transmits a uniform resource locator (URL) string which is used to download an Android application. The server 120 downloads the Android application guided by the URL on behalf of the smartphone 110, thereby inspecting whether the Android application is a malware.

The smartphone 110 requests the server 120 to perform an inspection with a URL string received through, for example, a short message service/multimedia messaging service (SMS/MMS), e-mail messages, and Internet-based online messengers. In this example, the smartphone 110 can also generate a signature for pre-installed application rather than the URL and deliver the generated signature to the server.

In response to the received URL string, the server 120 accesses a remote area server 130 corresponding to the URL string and downloads the Android application file 140. The server 120 then generates a signature 121 for the Android application. In addition, the server 120 unpackages and decompiles the download file 140 in order to get source codes from the file 140. The server 120 then extracts feature points for the source codes obtained. Also, the server 120 generates a signature for the feature points.

The server 120 computes the similarity between the generated signature and one of signatures for Android malware and normal applications, which are once verified earlier. To this end, the server 120 uses a database 122 in which the signatures of the Android malware and the normal applications are stored. To compute the similarity, the server 120 first divides the signatures stored in a database into fixed-sized substrings and then generates an inverted index with the substrings. The server 120 divides a given signature into substrings and search for signatures that include one or more of the substrings by looking up the inverted index. The server 120 sorts the found signatures on the basis of the number of substrings that both signatures commonly share, thereby identifying whether the Android application is a malware.

In this example, to compute the similarity, a similarity query index 123 built with signature values stored in a signature database is used to search for signatures most similar to a given signature rather than one-to-one comparisons. Furthermore, a malware inspection is performed with a few signatures which are the most similar to the given signature. The server 120 provides a result 150 of inspection indicating whether the most similar signatures are the malware or the normal application and a similarity value for the most similar signatures to the smartphone 110.

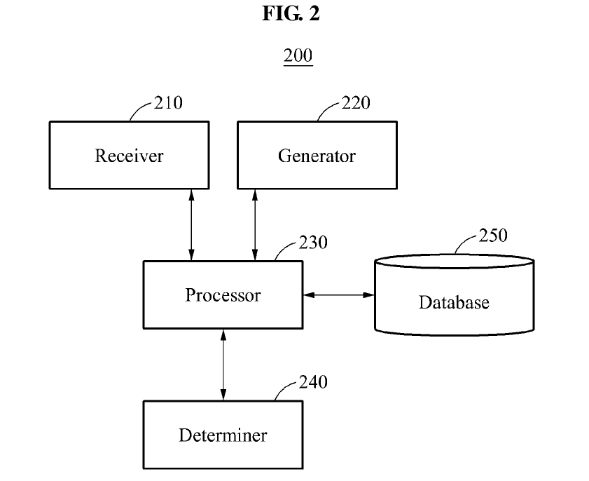

FIG. 2 illustrates an example of a system 200 for fast inspection of Android malwares in the server perspective.

The system 200 includes a receiver 210, a generator 220, a processor 230, a determiner 240, and a database 250.

The system 200 receives either a URL used for downloading a target application or a signature itself for the target application from a smartphone.

The receiver 210 receives either the signature for the target application or the URL used for downloading the target application. The generator 220 downloads the target application from a remote server indicated by a URL string when the receiver 210 receives the URL rather than the signature for the target application. Furthermore, the generator 220 creates a signature for the downloaded target application.

In this way, the system 200 obtains the signature for the target application.

The processor 230 computes the similarity between the signature for the target application and signatures stored in a database 250. In addition, the determiner 240 determines whether the target application is a malware based on the similarity.

The processor 230 divides the signatures stored in a database into substrings, builds an inverted index with the substrings, and then computes the similarity by looking up the inverted index with the substrings from the signature for the target application.

The processor 230 builds an inverted index by grouping data items for each substring extracted from signatures stored in a database. Each data item in the inverted index consists of the actual value of a signature which includes a substring, a position of the substring in the signature, and an identifier for an application represented by the signature.

In an example, the processor 230 generates substrings by splitting the signature for the target application, and search the inverted index for at signatures that include most of the substrings extracted from the signature for the target application. As an example, the processor 230 computes the similarity between signatures stored in a database and a signature for the target application by checking how many substrings are shared with each other.

The processor 230 searches data items including a signature value, a position value, and application identification (ID) information for given substrings.

Furthermore, the processor 230 sort the candidate signatures based on the frequency of the substrings appeared in a set of candidate signatures and computes the similarity between the signatures.

In the present disclosure, a malware inspection is also performed only using a URL string for installing an application in advance of the installing, and a fast inspection is ensured by performing a comparison with only candidate signatures traversed by the inverted index rather than all the signatures stored in a database.

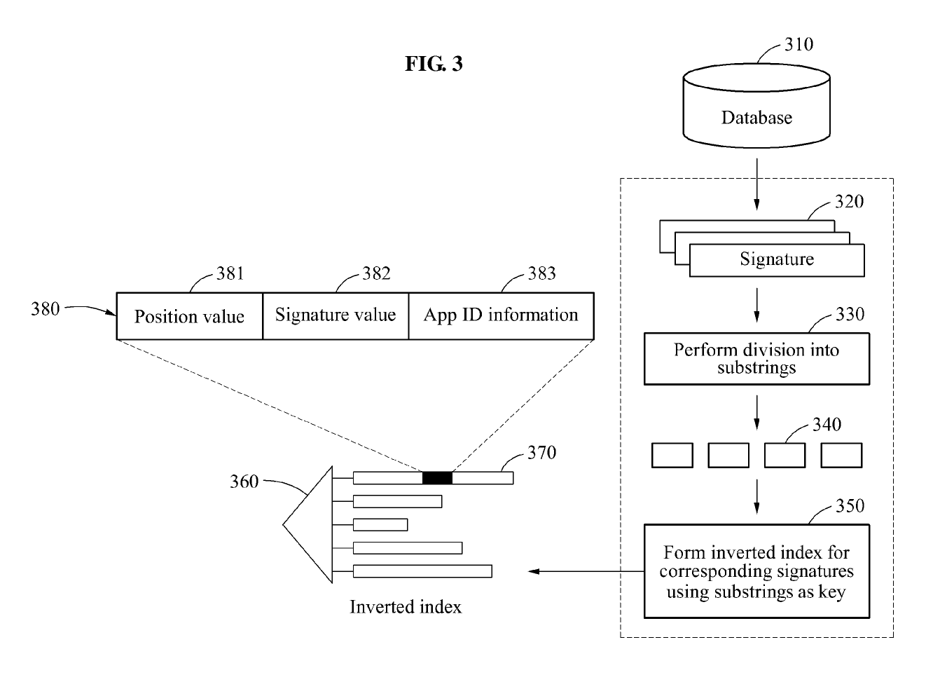

FIG. 3 illustrates an example of building a similarity query index with signatures stored in a database 310 of a server.

Signatures 320 for both normal applications and malwares be stored and maintained in the database 310. The signatures 320 be generated based on several methods including, for example, hashing and fuzzy-hashing.

In 330, the signatures 320 are divided into substrings 340 whose size is set to n.

In 350, a system for conducting a fast inspection of Android malwares according to example embodiments builds an inverted index 360 with the substrings 340. In 370, the inverted index 360 arranges data items for each of the substrings by grouping the data items by each of the substrings as a key. A data item 380 found in the inverted index 360 includes a signature value 382 of a signature in which a corresponding substring is originally included, a position value 381 indicating a position at which the corresponding substring is present in the signature, and application ID information 383 of an application represented by the signature.

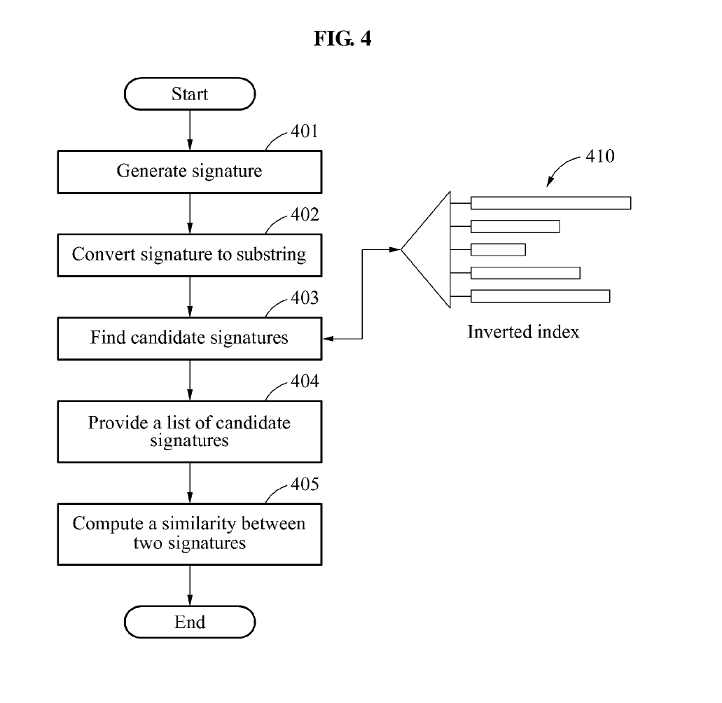

FIG. 4 illustrates an example of fast searching of signatures which can be similar to a given Android application by using an inverted index.

FIG. 4 illustrates a procedure of fast signature searching by using an inverted index 410 generated by a procedure of building a similarity query index described in FIG. 3.

A system for conducting fast inspection of Android malwares according to example embodiments generates a signature for an Android application file to be inspected, in 401. The generating of a signature is an operation of generating a smaller-sized value for a large body of a given application, and this process can be performed with various signature generating algorithms including, for example, hashing.

In 402, the system converts the generated signature for the Android application to a set of substrings by dividing the signature into substrings, each having a fixed size.

In 403, the system finds candidate signatures that contain the substrings by looking up the inverted index 410.

As an example, in 404, the system provides a list of candidate signatures sorted in descending order of the number of the substrings that includes.

In this way, in 405, the system computes the similarity between two signatures by counting the number of substrings that the two signatures commonly share.

Accordingly, in the present disclosure, the number of examining similarity for a given signature is reduced by performing the similarity check only with the signatures filtered through an index search without a need to perform similarity check for the signatures for all malwares and normal applications.

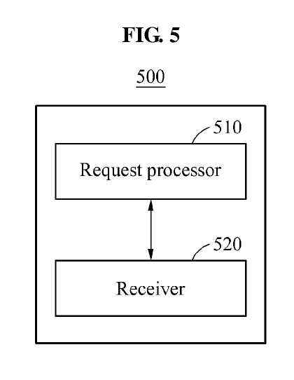

FIG. 5 illustrates an example of a system 500 for fast inspection of Android malwares in the client perspective.

The system 500 is composed of a request processor 510 and a receiver 520.

The request processor 510 sends a request message to a server to test a given Android malware. As an example, the request processor 510 requests the server to search for malwares or normal applications which are similar to the target application downloadable by a URL. As another example, the request processor 510 generates a signature for the target application and transfer the generated signature to the server, thereby request the server to search for malwares or normal applications verified earlier in the database.

The server builds an inverted index by dividing signatures stored in a database into substrings and compute similarity by checking the signature for the target application with the generated inverted index, thereby sending similarity information in response to the requests.

As an example, the server generates the inverted index by grouping data items by the substrings.

The server generates substrings from the signature for the target application, look up the inverted index to find candidate signatures with the substrings, and compute the similarity between one of signatures stored in a database and the signature for the target application on the basis of the number of substrings shared by both signatures.

The receiver 51 receives information on the similarity from the server in response to the requests.

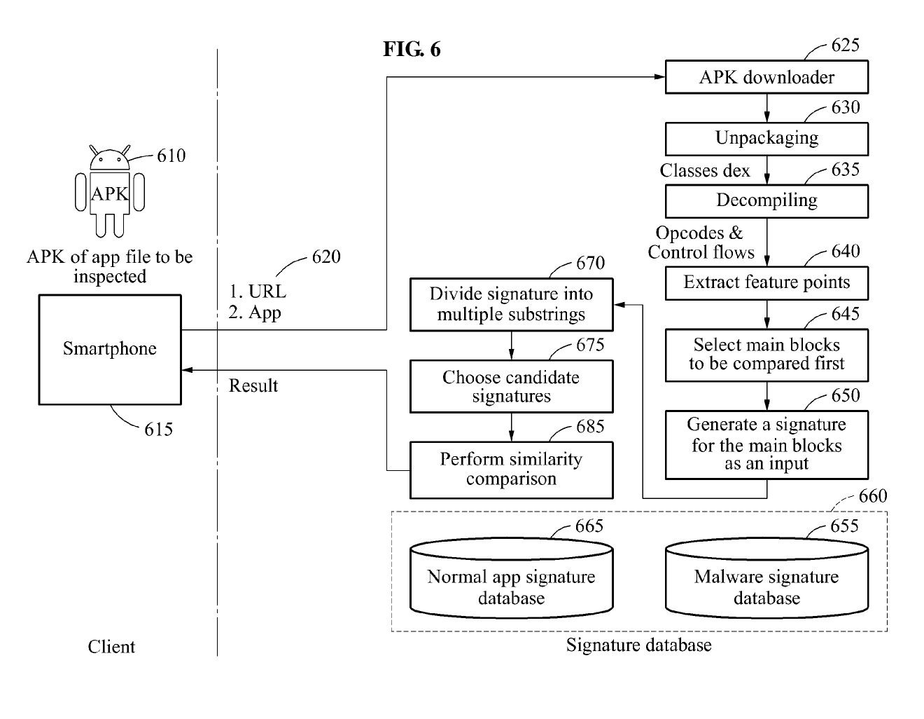

FIG. 6 illustrates an example of an overall procedure of malware inspection for an Android application, including the building of an inverted index with substrings from signatures stored in databases and a signature search performed with the inverted index.

In FIG. 6, the procedure includes the building of an inverted index for signatures stored in databases 660 and a signature search performed by using the inverted index. In a deployment, a smartphone operates as a client and the system works as a server that communicated with the smartphone.

A smartphone 615 has a URL string embedded in, for example, a received message and an e-mail. The URL string is address information that guides the server to download Android application file 610.

In 620, the smartphone 615 send the URL string for downloading the Android application file 610 to a server in order to check whether the Android application file 610 is a malware, or download the Android application file 610 using the URL string and generate information associated with the Android application file 610.

When the smartphone 615 makes a request for an inspection with a URL string, the Android application package file (APK) downloader 625 in the server downloads the Android application file 610 identified by the URL string on behalf of the smartphone 615.

The Android application file 610 downloaded by the server is unpackaged through a process of unpackaging 630 into multiple files. Among the files, an actual execution file, classes.dex, is used to perform a process of decompiling 635 to acquire a source code.

In 640, the system for conducting a fast inspection of Android malwares according to example embodiments extracts, from the source code, feature points by which the corresponding source code is to be identified. In 645, the system selects main blocks from the source code to extract the feature points. In 650, the system generates a signature for the main blocks as an input.

In 670, the system divides the generated signature into multiple substrings. In 675, the system chooses candidate signatures to be compared by looking up an index built with signatures stored in a signature database 660 for each of the substrings. In the case, the signature database 660 consists of two databases: a database 665 that stores signatures for verified normal applications and a database 655 that stores signatures for malwares verified earlier. In 685, the system performs a similarity comparison with the signatures and then sends its result to the smartphone 615.

Accordingly, the present disclosure provides a technology of inspecting whether an Android application is a malware. In detail, a server downloads the Android application through an URL instead of a smartphone and then performs a malware inspection on the Android application. In this way, the server performs a fast inspection on the Android application.

In an aspect of the present disclosure, it is possible to allow a server to perform an inspection on an Android application by performing a similarity comparison with signature values without need to fully perform the inspection on the whole application. In addition a server performs signature comparison by selecting a few candidate signatures by using an index; thereby the number of similarity comparisons is reduced so that a fast inspection is promised.

According to an example embodiment, it is possible to provide a method and system for a fast similarity-based inspection for Android malwares.

According to another example embodiment, it is possible to provide a method and system in which a server downloads an application via a URL to perform an analysis on behalf of a terminal, thereby conducting a fast and efficient inspection.

According to still another example embodiment, it is possible to provide a method and system for generating a signature for a corresponding application to conduct a fast inspection by using a similarity query index rather than one-to-one comparisons of signatures stored in a database in a server.

The methods according to the above-described embodiments be recorded, stored, or fixed in one or more non-transitory computer-readable media that includes program instructions to be implemented by a computer to cause a processor to execute or perform the program instructions. The media also include, alone or in combination with the program instructions, data files, data structures, and the like. The program instructions recorded on the media may be those specially designed and constructed, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher level code that be executed by the computer using an interpreter. The described hardware devices may be configured to act as one or more software modules in order to perform the operations and methods described above, or vice versa.

Although a few embodiments of the present disclosure have been shown and described, the present disclosure is not limited to the described embodiments. Instead, it would be appreciated by those skilled in the art that changes may be made to these embodiments without departing from the principles and spirit of the disclosure, the scope of which is defined by the claims and their equivalents.

What is claimed is:

1. A system for conducting a fast inspection of Android malwares, the system comprising:
a processor configured to compute a similarity between a signature of a target application and pre-stored signatures; and
a determiner configured to determine whether the target application is a malware based on the similarity between the signatures.

2. The system of claim 1, further comprising:
a receiver configured to receive the signature of the target application from a smartphone.

3. The system of claim 1, further comprising:
a generator configured to download the target application with the uniform resource locator (URL) which is received from a smartphone and then generate a signature for the downloaded target application.

4. The system of claim 1, wherein the processor is configured to divide the pre-stored signatures into substrings whose sizes are fixed, build an inverted index with the substrings, and compute the similarity between the signature for the target application and candidate signatures traversed by the inverted index.

5. The system of claim 4, wherein the processor is configured to build an inverted index by grouping data items for each substring, exploiting the each substring as a key.

6. The system of claim 5, wherein each data item in the inverted index comprises at least a signature value that includes its corresponding key, a substring, a position of the substring in the signature, and an identifier of an application represented by the signature.

7. The system of claim 4, wherein the processor is configured to create substrings with the signature for the target application and to search the inverted index for candidate signatures which include the substrings acquired from the signature for the target application.

8. The system of claim 7, wherein the processor is configured to compute the similarity between one of the pre-stored signatures and the signature for the target application on the basis of the number of substrings that both signatures commonly share each other.

9. The system of claim 8, wherein the processor is configured to search the inverted index for data items that include a signature value that contains at least one of the substrings generated from the signature for the target application.

10. A system for conducting a fast inspection of Android malwares, the system comprising:
a request processor configured to request a server to compute a similarity between the target application and malwares verified earlier;
a receiver configured to receive information on the similarity to the malware from the server in response to the requests,
wherein the server is configured to build an inverted index with substrings which are acquired by dividing signatures stored a database, compute a similarity by comparing the candidate signatures traversed by the inverted index with the signature for the target application, and then send the similarity information to a client in response to the request.

11. The system of claim 10, wherein the request processor is configured to request the server to compute the signature similarity by sending a uniform resource locator (URL) used to download the target application.

12. The system of claim 10, wherein the request processor is configured to generate a signature for the target application and send the generated signature to the server to to request the server to compute the similarity with the signature and signatures stored in a database in the server.

13. The system of claim 10, wherein the server is configured to generate an inverted index by grouping data items for each substring, which is acquired by splitting each of signatures stored in a database in a server.

14. The system of claim 13, wherein the server is configured to generate substrings from the signature for the target application, search the inverted index for candidate signatures which include at least one of the substrings, and compute the similarity between candidate signatures and the signature for the target application on a basis of the number of substrings that both signatures commonly share each other.

15. A method of conducting a fast inspection of Android malwares, the method comprising:
examining, by a processor, a similarity between a signature for a target application and signatures stored in a database; and
determining, by a determiner, whether the target application is a malware based on the computed similarity,
wherein the verifying comprises:
dividing the signatures stored in a database into multiple substrings and building an inverted index with the substrings; and
examining the similarity by comparing the signature for the target application with the candidate signatures traversed by the generated inverted index.

16. The method of claim 15, further comprising:
receiving the signature for the target application from a smartphone.

17. The method of claim 15, further comprising:
downloading the target application with a uniform resource locator (URL) received from a smartphone and generating the signature for the downloaded target application.

18. The method of claim 15, wherein the dividing comprises generating the inverted index by grouping data items for each substring as a key.

19. The method of claim 14, wherein the examining comprises:
generating substrings with the signature for the target application and searching the inverted index for signatures which include at least one of substrings acquired from the signature for the target application; and
examining the similarity between the one of signatures stored in a database and the signatures for the target application on the basis of the number of substrings that both signatures commonly share each other.

20. The method of claim 19, wherein the examining comprises searching the inverted index with the substrings acquired from the signature for the target applications in order to get data items each of which comprises a signature value, a position value, and application identification (ID) for given substrings.
